(19) United States
(12) Patent Application Publication
(10) Pub. No.: US 2024/0371017 A1
(43) Pub. Date: Nov. 7, 2024

(54) IMAGE PROCESSING APPARATUS, METHOD, AND PROGRAM

(71) Applicant: NIPPON TELEGRAPH AND TELEPHONE CORPORATION, Tokyo (JP)

(72) Inventors: Masato ONO, Musashino-shi, Tokyo (JP); Takashi SANO, Musashino-shi, Tokyo (JP); Yumi KIKUCHI, Musashino-shi, Tokyo (JP); Shinji FUKATSU, Musashino-shi, Tokyo (JP)

(73) Assignee: NIPPON TELEGRAPH AND TELEPHONE CORPORATION, Tokyo (JP)

(21) Appl. No.: 18/685,911

(22) PCT Filed: Sep. 8, 2021
(86) PCT No.: PCT/JP2021/033017

§ 371 Date: Feb. 23, 2024

(51) Int. Cl. G06T 7/50; H04N 23/958

(52) U.S. Cl. CPC G06T 7/50; H04N 23/958

(57) ABSTRACT

According to an embodiment, there is provided an image processing device including: a depth estimation unit that estimates a depth of an image; a depth optimization processing unit that outputs a depth map of the image by applying a depth optimization function used for mapping the depth to the depth estimated by the depth estimation unit; and a setting unit that performs histogram analysis of the depth map output by the depth optimization processing unit and sets a value of the depth of the image on a display screen based on a distribution of values of depths indicated by a result of the analysis.

### TECHNICAL FIELD

An embodiment of the present invention relates to an image processing device, an image processing method, and an image processing program.

### BACKGROUND ART

In order to generate a three-dimensional image from a two-dimensional image, a depth map representing depth information of an image is used. The depth map is data generated by mapping distance information (depth information) from a viewpoint of a user for each pixel of an image. The depth map can be expressed in gray scale. In the case of a general 8-bit gradation (0 to 255), a deepest portion is expressed by a minimum value of 0 (black) and a foremost portion is expressed by a maximum value of 255 (white).

In addition, in a case where a depth map is generated from a two-dimensional single perspective image or a stereo image (two images with parallax which are obtained by performing imaging from positions of a left eye and a right eye), data may be biased to a certain depth range. As a result, a value range of available bit gradation may not be effectively used. Remapping on such a depth map to use the value range to the maximum is referred to as depth optimization.

For example, Non Patent Literature 1 discloses a method of setting a position at which a gaze object is present for a display plane based on a fact that a range in which parallax is effectively felt by a user is around a display plane, setting a range from 5th percentile to 95th percentile in a value range of a depth range as a processing target, and remapping depth information in a non-linear manner.

A function used when the depth is remapped as described above will be referred to as a depth optimization function. In a case where depth optimization processing is performed on each of different images, the depth optimization function differs depending on a distribution of the depths in the image.

In addition, Non Patent Literature 2 discloses a method of deriving a parallax layer from a histogram analysis result of parallax and optimizing a depth within a certain range of a layer in which an object of interest is present. Therefore, it is possible to sufficiently express a depth of a detailed part of the object of interest.

### CITATION LIST

### Non Patent Literature

Non Patent Literature 1: Gaze Stereo 3D: Seamless Disparity Manipulations (Petr Kelnhofer, et al., “GazeStereo3D: Seamless Disparity Manipulations, “ACM Transactions on Graphics-Proceedings of ACM SIGGRAPH 2016, Volume 35, Issue 4, 2016.
Non Patent Literature 2: SangwooLee, YounghuiKim, JungjinLee, KyehyunKim, KyunghanLee and JunyongNoh, “Depth manipulation using disparity histogram analysis for stereoscopic 3D”, The Visual Computer 30 (4): 455-465, April 2014.

### SUMMARY OF INVENTION

### Technical Problem

In order to express a sense of depth of an image when a 3D image is produced, it is important to set a part of the image as a display plane without a sense of protrusion and set a sense of depth to some degree in front of and behind the display plane.

In a case where the above-described technique for optimizing the depth is directly applied to a moving image (video), setting of the display plane is not taken into consideration. As a result, for example, in a case where the depth is expressed in 256 steps, a fixed center value (a value of the 128th step) is set for the display plane, and thus there is a possibility that a stereoscopic effect appropriate for the user cannot be obtained.

That is, as a result of performing depth optimization processing, in a case where there is an object (a person or the like) having a depth value of 128, the object does not give a stereoscopic effect.

Specifically, in the case of performing 3D representation, an object located in front of the display plane is expressed as if the object were protruding from the display plane, and an object located behind the display plane is expressed as if the object were recessed.

Further, in a case where the display plane is set at a center point of the depth value, a sense of depth is not expressed for an object (a person or the like) that is set at the corresponding depth by chance.

The present invention has been made in view of the above circumstances, and an object of the present invention is to provide an image processing device, a method, and a program capable of appropriately setting a depth value corresponding to a display screen in an image in which a depth is represented.

### Solution to Problem

According to an aspect of the present invention, there is provided an image processing device including: a depth estimation unit that estimates a depth of an image; a depth optimization processing unit that outputs a depth map of the image by applying a depth optimization function used for mapping the depth to the depth estimated by the depth estimation unit; and a setting unit that performs histogram analysis of the depth map output by the depth optimization processing unit and sets a value of the depth of the image on a display screen based on a distribution of values of depths indicated by a result of the analysis.

According to another aspect of the present invention, there is provided an image processing method performed by an image processing device, the method including: a depth estimation step of estimating a depth of an image; a depth optimization processing step of outputting a depth map of the image by applying a depth optimization function used for mapping the depth to the depth estimated in the depth estimation step; and a setting step of performing histogram analysis of the depth map output in the depth optimization processing step and setting a value of the depth of the image on a display screen based on a distribution of values of depths indicated by a result of the analysis.

### Advantageous Effects of Invention

According to the present invention, it is possible to appropriately set the depth value corresponding to a display screen in an image in which a depth is represented.

### BRIEF DESCRIPTION OF DRAWINGS

FIG. 1 is a diagram illustrating an application example of a depth map generation device according to an embodiment of the present invention.

FIG. 2 is a flowchart illustrating an example of a processing operation by the depth map generation device according to the embodiment of the present invention.

FIG. 3 is a diagram illustrating an example of processing related to display plane setting by the depth map generation device according to the embodiment of the present invention.

FIG. 4 is a block diagram illustrating an example of a hardware configuration of the depth map generation device according to the embodiment of the present invention.

### DESCRIPTION OF EMBODIMENTS

Hereinafter, an embodiment according to the present invention will be described with reference to the drawings.

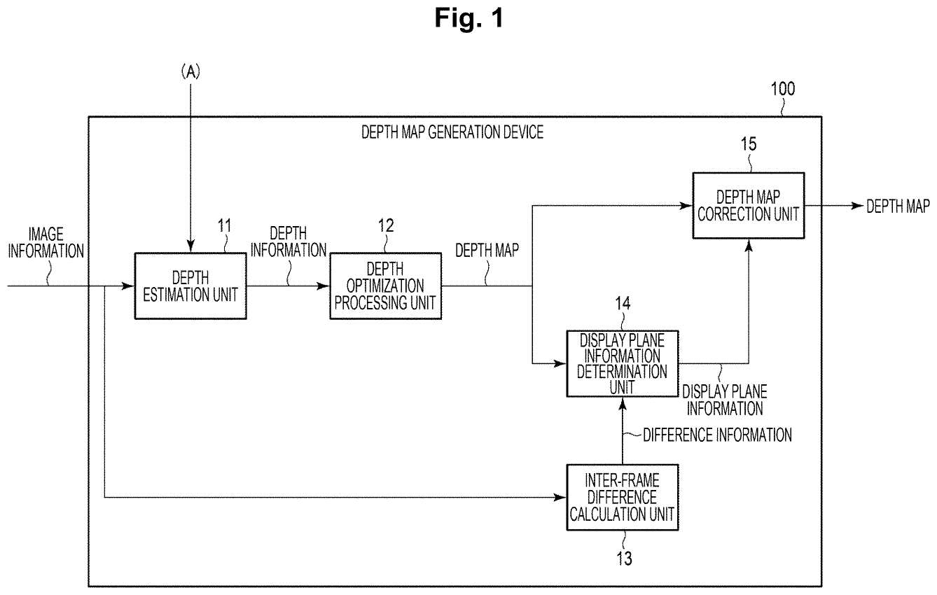

FIG. 1 is a diagram illustrating an application example of a depth map generation device according to an embodiment of the present invention.

As illustrated in FIG. 1, a depth map generation device 100 that is an image processing device according to an embodiment of the present invention includes a depth estimation unit 11, a depth optimization processing unit 12, an inter-frame difference calculation unit 13, a display plane information determination unit 14, and a depth map correction unit 15.

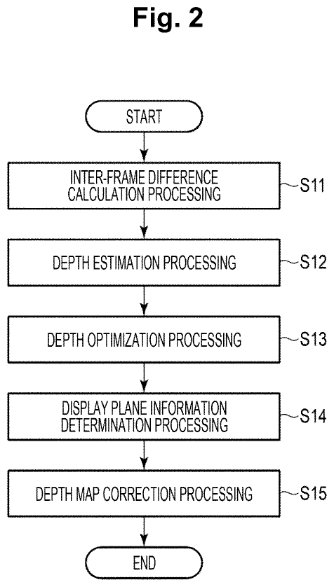

FIG. 2 is a flowchart illustrating an example of a processing operation by the depth map generation device according to the embodiment of the present invention. In the present embodiment, a moving image including a plurality of frames that are continuous in time series will be described as an image to be processed. On the other hand, a still image can also be used as long as the image includes depth information.

The inter-frame difference calculation unit 13 receives image information that is a moving image from the outside, for example, a single perspective image or a stereo image, and calculates an inter-frame difference that is difference information between a frame to be processed (also referred to as a subsequent frame) and a frame that is continuous with the frame in time series and is prior to the frame in time series (also referred to as a previous frame) in the image information (S11).

The depth estimation unit 11 receives the image information, estimates depth information of each frame of the image information, and outputs the estimated depth information to the depth optimization processing unit 12 (S12).

Note that, instead of the estimation processing by the depth estimation unit 11, a depth camera image that is an image associated with a time stamp may be used as the depth information (refer to (A) of FIG. 1).

The depth optimization processing unit 12 performs depth optimization processing of mapping, to each frame, the depth information corresponding to each frame based on the depth information from the depth estimation unit 11 and a predetermined depth optimization function, and outputs a depth map related to each frame to the display plane information determination unit 14 and the depth map correction unit 15 (S13).

The display plane information determination unit 14 analyzes the depth map from the depth optimization processing unit 12, calculates a display plane determination index value (which may be simply referred to hereinafter as an index value) with respect to a depth value indicated by the depth map based on a result of the analysis and the inter-frame difference from the inter-frame difference calculation unit 13, determines, for a display plane, a depth value indicated by a lowest index value among the depth values, and outputs display plane information indicated by the depth value to the depth map correction unit 15 (S14).

The depth map correction unit 15 corrects the depth map such that the depth value corresponding to the display plane is a predetermined depth value based on the depth map from the depth optimization processing unit 12 and the display plane information from the display plane information determination unit 14, and outputs the corrected depth map as a final depth map (S15).

Next, details of processing of each unit of the depth map generation device 100 will be described.

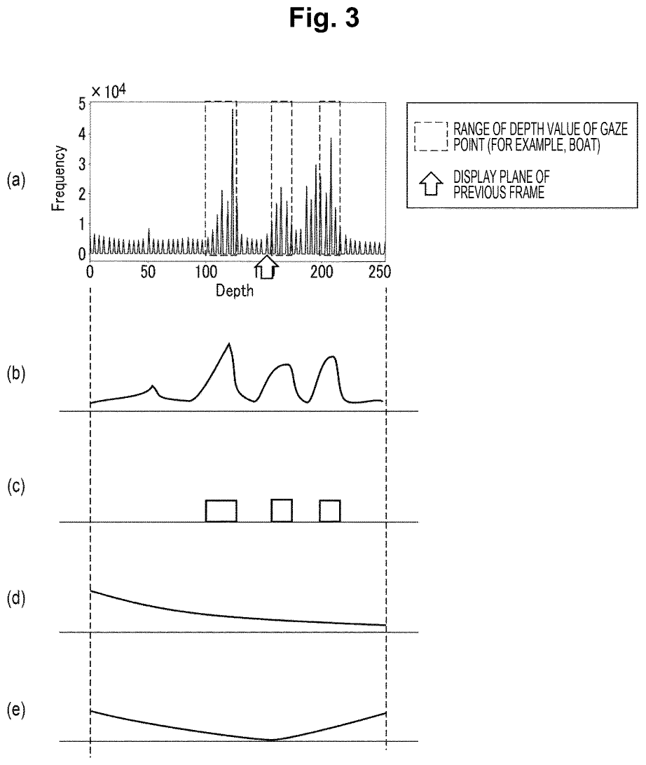

FIG. 3 is a diagram illustrating an example of processing related to display plane setting by the depth map generation device according to the embodiment of the present invention.

The display plane information determination unit 14 of the depth map generation device 100 has a function of analyzing the depth map ((a) of FIG. 3) and setting the display plane such that a value indicating that a subject is estimated to be present does not correspond to the display plane.

The display plane information determination unit 14 performs control such that a depth value having a high possibility that a gaze subject is present is not set for the display plane based on information related to the depth map. Specifically, the display plane information determination unit 14 calculates a display plane determination index value (hereinafter, referred to as an index value) for each depth value such that a depth value having a high possibility that a subject is present is a high index value and a depth value having a low possibility that a subject is present is a low index value, and sets, for the display plane, for example, a depth value having a relatively low index value.

The display plane information determination unit 14 performs histogram analysis of the depth map, and sets an index value related to a depth value, which is highly frequent among the depth values indicated by a result of the analysis, to a high value ((b) of FIG. 3).

At this time, in setting of the index value, the display plane information determination unit 14 may set an index value, which is within a constant range centered on a peak value instead of a simple ratio of the depth value, to a high value.

In addition, in a case where there is a result obtained by performing segmentation processing or tracking processing on a material image associated with a depth map, and in a case where there is an object (for example, a person or the like) that tends to be a gaze subject, the display plane information determination unit 14 may set a high index value for a depth value associated with a region of the object ((c) of FIG. 3).

Further, in the depth map to be processed, in a case where a depth value range is extended by the depth optimization processing, in consideration of an influence by a change of the depth value, the display plane information determination unit 14 may set a high index value in a case where a change amount of the depth value is large and set a low index value in a case where a change amount of the depth value is small ((d) of FIG. 3).

In a case where a display plane is set for each of continuous frames of a moving image, a sudden change in the display plane causes a sense of discomfort when viewing a 3D video. Therefore, the display plane information determination unit 14 can correct the index value by adding, to the index value of each depth value described above, a value according to a difference from the depth value which is set for the display plane of the previous frame ((e) of FIG. 3), and can set a depth value, on which the corrected minimum index value is based, for the display plane. The index value related to the depth value which is more frequently used may be corrected by adding values indicated in (c) to (e) of FIG. 3. In addition, all the values indicated in (c) to (e) do not necessarily need to be added, and correction may be performed by arbitrarily selecting the values.

As described above, by setting the display plane according to the index value, it is possible to prevent an object serving as a gaze point from being set for the display plane.

On the other hand, in a case where a scene change occurs between continuous frames, there is no problem even when the display plane varies. Therefore, in a case where a scene change is detected, the display plane information determination unit 14 does not need to consider the index value according to the difference from the display plane of the previous frame. Examples of a method of detecting a scene change include a method in which the inter-frame difference calculation unit 13 acquires an inter-frame difference and detects that a scene change occurs when the difference is equal to or higher than a certain value.

As another example, in a case where the depth value of the entire subject varies according to movement of the camera, for example, a zoom operation or a camera work, a sense of discomfort given to the user may be reduced when the display plane varies in a seamless manner. Therefore, the depth map correction unit 15 of the depth map generation device 100 can correct the index value based on a variation of a parameter of the camera.

The depth map correction unit 15 corrects the depth map using the information of the display plane which is set as described above. Specifically, the depth map correction unit 15 corrects each depth value of the depth map such that the display plane has a designated depth value.

For example, in a case where the depth value which is set for the display plane is 120 and the depth value is changed to 128 after the display plane is corrected, the depth map correction unit 15 extends the depth values within a range of 0 to 120 to a range of 0 to 128, and compresses the depth values within a range of 121 to 256 to a range of 129 to 256.

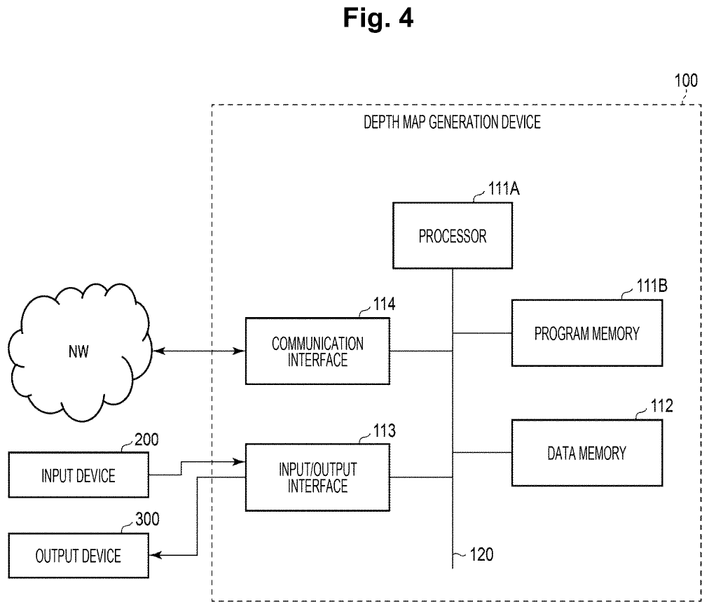

FIG. 4 is a block diagram illustrating an example of a hardware configuration of the depth map generation device according to the embodiment of the present invention.

In the example of FIG. 4, the depth map generation device 100 according to the embodiment is configured as, for example, a server computer or a personal computer and includes a hardware processor 111A such as a central processing unit (CPU). In addition, a program memory 111B, a data memory 112, an input/output interface 113, and a communication interface 114 are connected to the hardware processor 111A via a bus 120.

The communication interface 114 includes, for example, one or more wireless communication interface units and enables transmission/reception of information to/from a communication network NW. As the wireless interface, for example, an interface in which a low-power wireless data communication standard such as a wireless local area network (LAN) is adopted is used.

The input/output interface 113 is connected to an input device 200 and an output device 300 that are attached to the depth map generation device 100 and are used by a user or the like.

The input/output interface 113 performs processing of receiving operation data which is input by a user or the like via the input device 200 such as a keyboard, a touch panel, a touchpad, or a mouse, outputting output data to the output device 300 including a display device using liquid crystal, organic electro luminescence (EL), or the like, and displaying the output data on the output device 300. Note that the input device 200 and the output device 300 may be devices included in the depth map generation device 100 or may be an input device and an output device of another information terminal that can perform communication with the depth map generation device 100 via the network NW.

The program memory 111B is used as a non-transitory tangible storage medium, for example, as a combination of a non-volatile memory on which writing and reading can be performed as necessary, such as a hard disk drive (HDD) or a solid state drive (SSD), and a non-volatile memory such as a read only memory (ROM), and stores programs necessary for executing various kinds of control processing according to the embodiment.

The data memory 112 is used as a tangible storage medium, for example, as a combination of the above-described non-volatile memory and a volatile memory such as a random access memory (RAM), and is used to store various kinds of data acquired and created during various kinds of processing.

The depth map generation device 100 according to the embodiment of the present invention can be configured as a data processing device including the depth estimation unit 11, the depth optimization processing unit 12, the inter-frame difference calculation unit 13, the display plane information determination unit 14, and the depth map correction unit 15 illustrated in FIG. 1 that are processing function units by software.

Each information storage unit used as a working memory or the like by each unit of the depth map generation device 100 can be configured by using the data memory 112 illustrated in FIG. 4. Here, these configured storage areas are not essential configurations in the depth map generation device 100, and may be areas provided in, for example, an external storage medium such as a universal serial bus (USB) memory or a storage device such as a database server provided in a cloud.

All the processing function units in each of the depth estimation unit 11, the depth optimization processing unit 12, the inter-frame difference calculation unit 13, the display plane information determination unit 14, and the depth map correction unit 15 can be implemented by causing the hardware processor 111A to read and execute the programs stored in the program memory 111B. Note that some or all of these processing function units may be implemented in other various forms including an integrated circuit such as an application specific integrated circuit (ASIC) or a field-programmable gate array (FPGA).

In the present embodiment, in order to represent an effective 3D image, focusing on a fact that a depth at which a gaze point is present in the original image is related to the depth which is set for the display plane, by preventing an object as a gaze point from being provided for the display plane, it is possible to realize automatic generation of 3D content that can more easily obtain a three-dimensional effect.

Further, the method described in the embodiment can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as a program (software means) that can be executed by a computer, and can be distributed by being transmitted through a communication medium. Note that the programs stored on the medium side also include a setting program for configuring, in the computer, software means (including not only an execution program but also a table and a data structure) to be executed by the computer. The computer that implements the present device executes the above-described processing by reading the programs recorded in the recording medium, constructing the software means by the setting program as needed, and controlling the operation by the software means. Note that the recording medium in the present specification is not limited to a recording medium for distribution, and includes a storage medium such as a magnetic disk or a semiconductor memory provided inside a computer or in equipment connected via a network.

Note that the present invention is not limited to the above-described embodiment, and various modifications can be made at the implementation stage without departing from the gist of the invention. In addition, each embodiment may be implemented in appropriate combination, and in that case, a combined effect can be obtained. Furthermore, the above embodiments include various types of inventions, and various types of inventions can be extracted by a combination selected from a plurality of disclosed components. For example, in a case where problems can be solved and effects can be achieved even when some components are deleted from the entire components described in the embodiment, a configuration from which the components are deleted can be extracted as an invention.

### REFERENCE SIGNS LIST

100 Depth map generation device
11 Depth estimation unit
12 Depth optimization processing unit
13 Inter-frame difference calculation unit
14 Display plane information determination unit
15 Depth map correction unit

1. An image processing device comprising:
depth estimation circuitry that estimates a depth of an image;
depth optimization processing circuitry that outputs a depth map of the image by applying a depth optimization function used for mapping the depth to the depth estimated by the depth estimation circuitry; and
setting circuitry that performs histogram analysis of the depth map output by the depth optimization processing circuitry and sets a value of the depth of the image on a display screen based on a distribution of values of depths indicated by a result of the analysis.

2. The image processing device according to claim 1, wherein:
the setting circuitry calculates an index value for each of the values of the depths indicated by the distribution, and sets, as the value of the depth of the image on the display screen, a value of the depth used to calculate a lowest index value.

3. The image processing device according to claim 2, wherein;
the setting circuitry corrects the index value calculated for each of the values of the depths indicated by the distribution according to a value which is calculated for a value of a depth related to a region of a gaze object among the values of the depths indicated by the distribution.

4. The image processing device according to claim 2, wherein:
the setting circuitry corrects the index value calculated for each of the values of the depths indicated by the distribution according to a value which is calculated for a value of a depth to which the depth optimization function is applied by the depth optimization processing circuitry among the values of the depths indicated by the distribution.

5. The image processing device according to claim 2, wherein;
the image is a moving image including a plurality of frames,
a difference calculation circuitry that calculates a size of a region of a difference between one frame in a time series of the image and a frame at a timing later than a timing of the one frame is further included, and
the setting circuitry corrects the index value calculated for each of the values of the depths indicated by the distribution according to a level of the difference calculated by the difference calculation circuitry.

6. An image processing method, comprising:
estimating a depth of an image;
outputting a depth map of the image by applying a depth optimization function used for mapping the depth to the depth estimated in the estimating; and
performing histogram analysis of the depth map output in the outputting and setting a value of the depth of the image on a display screen based on a distribution of values of depths indicated by a result of the analysis.

7. The image processing method according to claim 6,
wherein the performing histogram analysis includes calculating an index value for each of the values of the depths indicated by the distribution, and setting, as the value of the depth of the image on the display screen, a value of the depth used to calculate a lowest index value.

8. A non-transitory computer readable medium storing an image processing program for causing a processor to perform the method of claim 5.
